(19) United States
(12) Patent Application Publication
(10) Pub. No.: US 2005/0196537 A1
(43) Pub. Date: Sep. 8, 2005

(54) Manufacturing process for porous ink-jet recording sheet

(75) Inventors: Shinichi Suzuki, Tokyo (JP); Keiji Ohbayashi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA PHOTO IMAGING, INC.

(21) Appl. No.: 11/067,765

(22) Filed: Mar. 1, 2005

(30) Foreign Application Priority Data
Mar. 4, 2004 (JP) JP2004-060241

(51) Int. Cl. B05D 3/02

(52) U.S. Cl. 427/372.2

(57) ABSTRACT

A manufacturing method for a porous ink-jet recording sheet is accomplishable by applying a water base coating composition onto a non-water-absorbing substrate and drying that coating, in which water base coating composition, in which a wet thickness H and a dry thickness D satisfy a specific relationship, and additionally a content of inorganic micro-particles and a viscosity are within specified ranges.

### FIELD OF THE INVENTION

The present invention relates to a production method of an ink-jet recording sheet having a porous ink absorbing layer, specifically relates to a production method of a porous ink-jet recording sheet which exhibits improved uniform layer coating and improved productivity.

### BACKGROUND OF THE INVENTION

In recent years, rapid improvement of ink-jet recording materials has been achieved, resulting in quality approaching that of conventional silver halide photography. Specifically, in order to enable to achieve image quality still more comparable to silver halide photography, improvement has been enhanced with regard to ink-jet recording sheets. Recording sheets provided with a porous ink absorbing layer onto a very flat and smooth substrate, incorporating a porous layer of minute voids, enables a closer approach to silver halide photography quality, due to a high ink absorbability and fast drying characteristics.

Incidentally, as a very flat and smooth substrate, generally employed is a non-water-absorbing substrate which does not absorb ink, such as polyester film, polyolefin film, or a paper substrate coated with polyolefin. In the case of applying an ink absorbing porous layer onto these non-water absorbing substrates, it is necessary to provide a porous layer of sufficient thickness to absorb quantity of ink. Usually, in cases when a porous layer is applied onto a non-ink-absorbing substrate, the layer is coated at a dry thickness of 30-50 μm.

To obtain such a thick dry thickness, coating is conducted at a correspondingly higher wet coating thickness. When applying a water base coating composition onto a substrate, listed drawbacks are the required drying time and unevenness due to drift caused by blown air during drying.

Since water, being a main solvent of an aqueous solution exhibits a high boiling point, it takes a very long time to dry employing only a heating process, requiring a significantly lengthy drying zone to increase the coating rate.

On the other hand, while the coated composition is dried over such a relatively long time, the coated liquid is moved locally by various causes, one being an uneven coated surface due to so-called “liquid drift by blowing”. Once drift is caused, not only the coated surface becomes uneven, but also the thickened portions result in spotty insufficient drying, resulting in serious subsequent trouble in manufacturing, as when the substrate is wound up as rolls.

Examples of coating a water base coating composition of a thick wet coating thickness, include a coating of a silver halide photographic emulsion employing gelatin as a hydrophilic binder. An aqueous gelatin solution is generally in an aqueous solution state at a temperature of more than about 30° C., but it exhibits characteristics to gelate at under 20-25° C. Taking advantage of these characteristics, an aqueous solution containing gelatin is coated onto a substrate, and after cooling to initiate gelating, it is possible to completely dry it at a relatively low temperature (being about 20-80° C.) but via strong blown air.

Consequently, in cases when employing gelatin, the problems accompanying drying time of gelatin are overcome. However, in cases when a coating composition, in preparation of a porous type ink-jet recording sheet, gelatin cannot be employed as the main hydrophilic binder, because gelatin is immediately swelled by ink to close voids, negating most of their beneficial characteristics.

In cases when a porous type ink-jet recording sheet is prepared, the above problems may be overcome to some extent by adjusting viscosity of the coating composition. However, only by adjusting viscosity of the coating composition, new problems arise as easily generating coating defects, such as minute cracks.

From such a viewpoint, disclosed is a recording sheet featuring a viscosity of 0.01-0.1 Pa·s at 40° C. which is obtained by applying a coating composition at a viscosity of 15° C., being more than 20 times of that of 40° C. (For example, please refer to following Patent Document 1.)

With this technique, liquid drift due to strong blown air and minute cracks following coating are significantly reduced. However, based on high picture quality of recent ink-jet processes, coating quality which was not a major problem up to this point, is emerging as an image quality concern. One such problem is minute streaking appearing as a cracked surface (forming a reticulating pattern) on the porous ink absorbing layer surface.

As a result of diligent investigation, the inventors found that the requirements of the coating composition of this invention eliminated the minute streaking of the surface.

Hence, in the drying process of the porous ink absorbing layer, the coating composition forming the porous layer allows gradual release of moisture from the surface, and the coated layer dries while shrinking. In this process, the viscosity of the coated composition rises gradually. In this case, viscosity elevation in the early stages of drying is relatively low, but when the coating thickness becomes about 2.5 or fewer times of the dry thickness, the coated layer forms a very strong gel. This gel formation is due to the interaction among inorganic micro-particles, resulting in formation of the porous membrane.

When the coated layer shrinks during the drying process, and gel strength of the coating is low, it has been proven that reticulation-like streaking defect tends to be generated. Specifically, it has been proven that in cases when the time of early low gel strength is relatively long, the tendency of the reticulation-like streak defect is more likely to be generated.

Patent Document 1: Unexamined Japanese Patent Application Publication (hereinafter, referred to as JP-A) 2000-218927.

### SUMMARY OF THE INVENTION

An object of the present invention is to provide a method for producing a porous ink-jet recording sheet which decreases generation of reticulation streaking.

The above method is accomplished by applying a water base coating composition on a non-water-absorbing substrate and drying that coating, in which water base coating composition, a wet thickness of H and a dry thickness of D satisfy a specific relationship, and content of inorganic micro-particles and viscosity are in the specified ranges.

### DETAILED DESCRIPTION OF THE INVENTION

The above objects of the present invention can be achieved via the following constitutions.

Item 1. A method for producing a porous ink-jet recording sheet comprising the steps of:

(i) applying a water base coating composition comprising inorganic micro-particles, polyvinyl alcohol, and substantially no gelatin, onto a non-water-absorbing substrate, and

(ii) drying the applied coating composition on the substrate,

wherein a wet thickness of the water base coating composition H (μm) and a dry thickness D (μm) satisfy the following relationship:
3.5≦H/D≦4.2

a content of the inorganic micro-particles in the water base coating composition is not less than 12 weight %, and a viscosity of the water base coating composition is 0.050-1.000 Pa·s at 40° C.

Item 2. The method for producing a porous ink-jet recording sheet of Item 1 above,

wherein at least two kinds of water base coating compositions are simultaneously applied onto the non-water-absorbing substrate,

a wet thickness of one of the water base coating composition H (μm) and a dry thickness D (μm) satisfy the following relationship:
3.5≦H/D≦4.2

a content of inorganic micro-particles in the water base coating composition is not less than 12 weight %; and

a viscosity of the water base coating composition is 0.050-1.000 Pa·s at 40° C.

Item 3. The method for producing a porous ink-jet recording sheet of Item 1 or 2 above,

wherein a viscosity of the water base coating composition at 15° C. is at least 20 times of the viscosity at 40° C., and

the water base coating composition is applied onto the non-water-absorbing substrate in the range of 35-50° C.

Item 4. The method for producing a porous ink-jet recording sheet of any one of Items 1-3, wherein after the water base coating composition is applied onto the non-water-absorbing substrate, the temperature of the applied layer is cooled to less than 20° C. to increase viscosity, after which it is dried with a warm air current.

Item 5. The method for producing a porous ink-jet recording sheet of any one of Items 1-4, wherein a layer resulting from applying the water base coating composition onto the non-water-absorbing substrate and drying is a porous ink absorbing layer, and the void ratio of the porous ink absorbing layer is 60-70%.

Based on this invention, it is possible to produce a recording sheet which exhibits a high ink absorbability and fast drying characteristics, and to obtain images which are similar in image quality of silver halide photography without liquid drift due to blown air nor unevenness when using the recording sheet.

The present invention will now be described in further detail. The water base coating composition of this invention contains inorganic micro-particles and polyvinyl alcohol, but it contains basically no gelatin.

Examples of the inorganic micro-particle include a white inorganic pigment, such as precipitated calcium carbonate, heavy calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatomaceous earth, calcium silicate, magnesium silicate, composite amorphous silica, colloidal silica, alumina, colloidal alumina, pseudo boehmite, aluminum hydroxide, lithophone, zeolite, and magnesium hydroxide.

Such inorganic micro-particles may be employed in a state of as-is primary particles, or in a state of forming secondary coagulated particles. With the view of relatively easily obtaining the water base coating composition featuring desirable viscosity of this invention, silica is preferred as an inorganic micro-particle source, and specifically most preferable is the use of micro-particle silica synthesized via a gas phase method.

Micro-particle silica synthesized via a gas phase method is generally silica powder which is prepared by burning silicon tetrachloride with hydrogen and oxygen at a high temperature, resulting in an average primary particle diameter of 5-500 nm, and in this invention, specifically preferred is a silica powder having an average primary particle diameter of less than 50 nm, from the viewpoint of glossiness.

The above silica synthesized via a gas phase method may be one having a cation modified surface, having a surface treated with Al, Ca, Mg or Ba, or having a surface partially made to be hydrophobic.

Any common particle diameter of the above inorganic micro-particles may be employed, however, from the viewpoint of ease to obtain the coating composition featuring desirable viscosity shown in this invention, that is, the viscosity of the coating composition varies widely based on temperature variation of the coating composition, the average particle diameter is preferably less than 0.3 μm, is specifically preferable less than 0.1 μm.

The lower limit of the particle diameter is not theoretically restricted, but from the viewpoint of mass production of such particles, the preferred diameter is more than about 3 nm, and specifically preferred is more than 6 nm.

With respect to the foregoing, the average diameter of the inorganic micro-particles may be determined as follows. The cross-section or surface of a porous ink absorbing layer is observed employing an electron microscope, and the diameter of 100 randomly selected particles is determined. The simple average (being the number average) is obtained as the average diameter of the particles based on the calculated diameter. Herein, each particle diameter is represented by the diameter of a circle having the same projection area as that of the particle.

Content of the above inorganic micro-particles in the water base coating composition is necessarily more than 12 weight %. In cases when it is less than 12 weight %, reticulating streaking tends to be generated during the coating operation, even if H/D is set within the range of 3.5-4.2. The specifically preferable content of inorganic micro-particles is not less than 13 weight %. Although the upper limit depends on viscosity of the coating composition, to bring the viscosity of the coating composition within 0.050-1.000 Pa·s at 40° C., typically the content is not more than about 17 weight %, but is preferably a maximum of 16 weight %.

The water base coating composition of this invention contains polyvinyl alcohol as a binder.

In cases when the polyvinyl alcohol employable in this invention is one prepared by hydrolysis of polyvinyl acetate, its average degree of polymerization is preferably not less than 300, but specifically polyvinyl alcohol featuring the average degree of polymerization of 1,000-5,000 is preferably employed. The saponification ratio is preferably 70-100%, but is more preferably 80-99.5%.

Further, polyvinyl alcohol derivatives employable in this invention include, in addition to common polyvinyl alcohol prepared by hydrolyzing polyvinyl acetate, modified polyvinyl alcohol such as terminal cation-modified polyvinyl alcohol and anion-modified polyvinyl alcohol incorporating an anionic group.

Cation-modified polyvinyl alcohols are, for example, polyvinyl alcohols incorporating a primary to a tertiary amino group, or a quaternary ammonium group in the main chain or side chain of the polyvinyl alcohols as described in JP-A 61-10483, which can be obtained upon saponification of copolymer of ethylenic unsaturated monomers having a cationic group, and vinyl acetate.

Listed as examples of ethylenic unsaturated monomers having a cationic group are trimethyl-(2-acrylamido-2-methypropyl)ammonium chloride, trimethyl-(3-acrylamido-3-methylbutyl)ammonium chloride, N-vinylimidazole, N-vinyl-2-methylimidazole, N-(3-dimethylaminopropyl)methacrylamide, hydroxylethyltrimethylammonium chloride, trimethyl-(3-methacrylamidopropyl)ammonium chloride, and N-(1,1-dimethyl-3-dimethylaminopropyl)acrylamide.

The content ratio of monomers containing a cation-modified group of the cation-modified polyvinyl alcohol is 0.1-10 mol % to the vinyl acetate, and is preferably 0.2-5 mol %.

Listed as examples of anion-modified polyvinyl alcohols are polyvinyl alcohols having an anionic group as described in JP-A 1-206088, copolymers of vinyl alcohols and vinyl compounds having a water solubilizing group as described in JP-A Nos. 61-237681 and 63-307979, and modified polyvinyl alcohols containing a water solubilizing group as described in JP-A 7-285265.

Further, listed as examples of nonion-modified polyvinyl alcohols are polyvinyl alcohol derivatives in which a polyalkylene oxide group is adducted to a part of polyvinyl alcohol as described in JP-A 7-9758, and block copolymers of vinyl compounds having a hydrophobic group and polyvinyl alcohols as described in JP-A 8-25795.

Polyvinyl alcohol and its derivatives, in which the degree of polymerization or modification differs, may be employed in a combination of at least two types.

The ratio of inorganic micro-particles to polyvinyl alcohol is preferably 3-10, from the viewpoint of easy adjustment of solution viscosity to the desirable range in this invention, and specifically, is most preferably 4-8.

In this invention, the expression “containing basically no gelatin” means that gelatin is not contained in the composition as a main component, but specifically it is a component which contains no gelatin at all, or which contains gelatin so little that it does not exhibit the function to close the voids of the porous type recording layer of this invention. Generally, gelatin content to polyvinyl alcohol is a maximum of 20 weight %, and preferably a maximum of 10 weight %.

The water base coating composition of this invention contains polyvinyl alcohol as a main binder, and other hydrophilic binders other than gelatin, may be employed in combination, as long as the fluid viscosity is within the range of this invention.

Examples of such hydrophilic binders include polyethylene oxide, polyvinylpyrrolidone, polyacrylic acid, polyacrylamide, polyuretane, dextran, dextrin, carrageenan, vegetable gelatin, pullulan, water-soluble polyvinyl butyral, hydroxyethyl cellulose, and carboxymethyl cellulose.

Preferably, the hydrophilic binder to polyvinyl alcohol is a maximum of about 20 weight %, and specifically preferably not more than 10.

When the coating composition employed in this invention is applied onto a substrate at a wet coating thickness H (μm) and a dry thickness D (μm), the ratio of H/D is required to be in the range of 3.5-4.2. In cases when H/D is 3.5 or less and viscosity of the coating composition at 40° C. is in the range of 0.050-1.000 Pa·s, the void ratio tends to decrease due to reduced interaction among the inorganic micro-particles in the coating composition. In this case, the void ratio is decreased, and to maintain the desired void volume, it is necessary to conduct coating at higher wet coating thickness and higher solid content coverage, resulting in not only disadvantageous cost, but also in excessive curling of the recording sheet.

In the case of H/D being less than 3.5 while interaction among the inorganic micro-particles is maintained to keep sufficient voids, viscosity of the coating composition is extremely raised, and results in difficult stable coating. Thus, blurring streaks may be generated, or the thickness of coated layers in the lateral direction tends to fluctuate widely. Specifically, when blurring streaks are generated, the tendency of cracking defects at a high level near the streaks resulting from changes of layer thickness, tends to increase.

On the other hand, in cases when H/D exceeds 4.2, conspicuous reticulating streaks are generated during coating and drying process. Specifically, when it exceeds 5, the liquid tends to flow to the sides of the substrate, resulting in very low film layer uniformity in the lateral direction.

To adjust H/D within the above range, various methods exist, and may be employed for optional effect. Specifically, the desired H/D value is attained via appropriate adjustment, such as the kind of inorganic micro-particle (specifically being a composition, e.g., silica.alumina type, average particle diameter, distribution of particle diameters, modification of particle surface, and shapes of inorganic micro-particles), ratio of polyvinyl alcohol to inorganic micro-particles, pH of the coating composition, content of inorganic salts in the coating composition, amount of a cross-linking agent of polyvinyl alcohol (such as boric acids or epoxy compounds), amount of cationic polymer or other hydropholic polymers, and further concentrations of surface active agents and water-miscible solvents (such as methanol and acetone).

The water base coating composition of this invention features a viscosity of 0.050-1.000 Pa·s at 40° C., but from the viewpoint of producing a uniformly coated layer surface, it is preferably to make it 0.050-0.500 Pa·s. Further, the viscosity at 15° C. is preferably more than 20 times at 40° C. Specifically preferable, the viscosity at 15° C. is more than 50 times the viscosity at 40° C., but more preferably it is more than 100 times. In this invention, viscosity is a value determined by employing a Brookfield Viscometer.

To achieve the viscosity characteristics described above, while maintaining the specified H/D ratio and the. concentration of the inorganic micro-particles being 12 weight %, it is essential to optimize the various above factors, however, specifically preferred are the following parameters:

a) incorporating boric acids or salts thereof,

b) employing polyvinyl alcohol having an average polymerization degree of 2,000-4,000,

c) employing silica as an inorganic micro-particle at a weight ratio of 4-6 times that of polyvinyl alcohol,

d) adding a surface active agent in an amount of 0.01-1 weight % in the coating composition,

e) employing a water-miscible solvent in an amount of 1-5 weight % in the coating composition,

f) adding a polymer latex to the coating composition, and

g) adding a photo cross-linking polyvinyl alcohol to the coating composition, and after coating, light such as UV rays are irradiated to elevate the viscosity of the coated solution.

In the above description, as a surface active agent, in cases when the water base coating composition is cationic, a cationic surface active agent, an amphoteric surface active agent or a nonionic surface active agent is preferably employed, while when the coating composition is an anionic, an amphoteric surface active agent, a nonionic surface active agent or an anionic surface active agent is preferably employed.

As water-miscible organic solvents, listed are alcohols such as methanol, ethanol, n-propanol, and i-propanol; ketones such as acetone, and methyl ethyl ketone; esters such as ethyl acetate, and propyl acetate; amides such as N,N-dimethylformamide; as well as polyols such as ethylene glycol, diethylene glycol, and glycerin.

As polymer latexes, employable are various latexes such as silicon oil, vinyl acetate latex, acrylic latex, and urethane latex.

In the water base coating composition of this invention, various additives other than the above-mentioned ones may be incorporated. Of these, a cation mordant is preferable in order to improve water resistance and moisture resistance after printing. As a cation mordant, employed may be a polymer mordant incorporated a primary, secondary or tertiary amino group, or a quaternary ammonium base, however, the polymer mordant incorporating a quaternary ammonium base is preferred due to little discoloration and light fading over time while exhibiting sufficiently high mordanting capability.

A preferable polymer mordant may be obtained as a homopolymer of the monomer incorporating the above quaternary ammonium base, or a copolymer or condensation polymer with the other monomers.

Other than the above, added may be various well-known additives such as UV absorbing agents described in JP-A Nos. 57-74193, 57-87988 and 62-261476; anti-fading agents described in JP-A Nos. 57-74192, 57-87989, 60-72785, 61-146591, 1-95091 and 3-13376; anionic, cationic or nonionic surface active agents; fluorescent brightening agents described in JP-A Nos. 59-42933, 59-52689, 62-280069, 61-242871 and 4-219266; anti-foam agents; lubricating agents such as diethylene glycol; antiseptic agents; viscosity increasing agents; anti-static agents; and matting agents.

A porous ink-jet recording sheet of this invention has at least one layer of a porous ink absorbing layer on a non-water-absorbing substrate, further the porous ink absorbing layer may be structured only one layer, or more than two layers.

In cases when the porous ink absorbing layer is structured of one layer, it is only required that the ratio of H to D is within the range of 3.5-4.2.

Further, when the porous ink absorbing layer is structured of plural layers, it is acceptable that at least one layer satisfies the above requirement, but it is preferable that more than 70% of the total wet coating thickness of the coating compositions satisfies the above requirement, while specifically preferable is that more than 90% of the total wet thickness satisfy that. However most preferred is all of the coating compositions forming the layers satisfy the above requirement.

Further, in the case of a multiplayer structure, it is necessary to simultaneously coat all porous ink absorbing layers, from the viewpoint of higher productivity and lowered production cost.

As non-water-absorbing substrate employable for the recording sheet of this invention, any of the well-known substrates may be employed, for example, a transparent film such as polyester film, diacetate film, triacetate film, acrylate film, polycarbonate film, polyvinyl chloride film, polyimide film, cellophane, or celluloid; or translucent or opaque film such as resin coated paper (being the so-called RC Paper) which has a polyolefin resin coated layer on at least one side of the base paper, or so-called white PET which is made by adding a white pigment such as titanium oxide or barium sulfide to the polyethylene terephthalate resin.

When conducting the production method of this invention employing the above substrate, it is preferable that the substrate is subjected to a corona discharge treatment or a subbing treatment, with the aim of enhancing adhesive strength between the surface of this substrate and a coated layer. Further, since the recording sheet produced by this invention is not always necessarily colorless, a colored substrate may be employed.

A preferably employed substrate when employing this invention, is transparent polyester film, opaque polyester film, opaque polyolefin film, or a paper substrate, both sides of which are coated with polyolefin.

Specifically preferable is the paper substrate, both sides of which are covered with polyethylene, in regard to which will be described in detail below.

Paper employed in the substrates consists mainly of wood pulp, and alternatively, synthetic pulp such as polypropylene or synthetic fiber such as nylon and polyester, mixing with the wood pulp. Employed as the wood pulp may be any of LBKP, LBSP, NBKP, NBSP, LDP, NDP, LUKP, and NUKP. However, it is preferable that LBKP, NBSP, LBSP, NDP, and LDP comprising short fibers in a relatively large amount, is employed. Incidentally, the ratio of LBSP and/or LDP is preferably between 10-70 weight %.

Preferably employed as the foregoing pulp is chemical pulp (sulfate pulp or sulfite pulp) containing minimal impurities. Further, also useful is pulp which has been subjected to a bleaching treatment to enhance whiteness.

Suitably incorporated into the paper base may be sizing agents such as higher fatty acids and alkylketene dimers; white pigments such as calcium carbonate, talc, and titanium oxide; paper strength enhancing agents such as starch, polyacrylamide, and polyvinyl alcohol; fluorescent brightening agents; moisture retention agents such as polyethylene glycols; dispersing agents; and softeners such as quaternary ammonium.

The degree of water freeness of pulp employed for paper making is preferably between 200 and 500 ml based on CSF Specification. Further, the sum of the weight % of 24-mesh residue and the weight % of 42-mesh residue regarding the fiber length after beating, specified in JIS-P-8207, is preferably 30-70%. Further, the weight % of 4-mesh residue is preferably not more than 20 weight %.

The basis weight of the paper base is preferably 30-250 g, but is specifically preferably 50-200 g. The thickness of the paper base is preferably 40-250 μm.

During the paper making stage, or alternatively after paper making, the paper base may be subjected to a calendering treatment to achieve higher smoothness. The density of the paper base is generally 0.7-1.2 g/m³ (JIS-P-8118). Further, the stiffness of the paper base is preferably 20-200 g under the conditions specified in JIS-P-8143.

Surface sizing agents may be applied onto the paper base surface. As surface sizing agents, the foregoing sizing agents, capable of being added to the paper base, may be employed.

The pH of the paper base, when determined employing the hot water extraction method specified in JIS-P-8113, is preferably 5-9.

Polyethylene, which preferably covers both surfaces of the paper, is comprised mainly of low density polyethylene (LDPE) or high density polyethylene (HDPE), but it is also possible to employ small amounts of LLDPE and polypropylene.

Specifically, rutile or anatase type titanium oxide is preferably incorporated into the polyethylene layer on the ink absorbing layer side, which tends to improve opacity and whiteness, which is widely conducted in photographic print paper production. The content ratio of titanium oxide is commonly 2-20 weight % with respect to the polyethylene, but is preferably 3-13 weight %.

Polyethylene coated paper may be used in this invention as a glossy paper, as well as a matte surface or silk surface paper, formed via an embossing process, during melt extrusion coating of the polyethylene onto the paper base, each of which is commonly conducted in paper production for photographic prints.

The usage of polyethylene for both sides of the paper base is chosen to optimize thickness of the water base coating composition, and to reduce curling at low and high humidity, after providing a backing layer. A polyethylene layer on the coating side of the water base coating composition of this invention is typically in the range of 20-40 μm, and is from 20-50 μm on the backing layer side.

Further, the foregoing paper substrate covered with polyethylene preferably exhibits the following properties:

1) Tensile strength: tensile strength in the longitudinal direction is preferably 2-30 kg, and that in the lateral direction is 1-20 kg in terms of strength specified in JIS-P-8113.

2) Tear strength: tear strength in the longitudinal direction is preferably 10-200 g, and 20-200 g in the lateral direction as specified in JIS-P-8116.

3) Compression elastic modulus≧1.01×10⁵ pa

4) Surface Bekk smoothness smoothness of a glossy surface is preferably 20 sec. or more under the condition specified in JIS-P-8119, but that of so-called embossed surfaces may be a lower value. Bekk smoothness of the backing layer side is not specifically limited, but is preferably about 20-500 sec.

5) Opacity: when measured employing the measuring conditions of straight light incidence/diffusion light transmission, the transmittance of visible light is preferably not more than 20%, but more preferably not more than 15%.

Next, the simultaneous coating methods of the water base coating composition of this invention will be described.

The production method of this invention is to apply the water base coating composition of this invention onto a non-water-absorbing substrate. Preferable methods include a curtain coat method, and an extrusion coat method employing a hopper described in U.S. Pat. No. 2,681,294.

The temperature of the coating composition during coating is preferably 35-50° C. In cases when it is less than 35° C., a portion of the fluid increases its viscosity rapidly during coating, resulting in unstable layer coating. While, when exceeding 50° C., rapid evaporation of water is generated at the slide surface or a coated surface after coating, after which convection occurs in the coated layer, resulting in the tendency of uneven coating. The preferable coating temperature is in the range of 37-45° C.

During drying, immediately after coating, it is preferable to cool the coated layer surface to less than 20° C., whereby the deposited composition rapidly gelates, and during the subsequent drying process, coating defects due to liquid drifting and blown liquid, are minimal. Cooling time is not specifically limited, and is preferably about 1-60 sec., but more preferably 2-10 sec.

During the subsequent drying, from the productivity point of view, it is preferable to heat the coated layer under the condition that it is not melted again.

It is preferable that about 20-80° C. air blow for drying is conducted. Relative humidity of the blown air is generally less than 60%, preferably less than 40%, but more preferably less than 20%.

Further, it is preferable that the temperature of the blown air is gradually raised as drying proceeds. Although total drying time depends on the wet coating thickness, usually it is preferable within about 10 minutes, more preferably within 5 minutes, but still more preferably within 3 minutes. As drying time is extended, reticulating streaks tend to be generated, and specifically, the time required to make the coated layer thickness twice that of the dry thickness, is preferably as short as possible, and is preferably within three minutes, but is specifically preferably within two minutes.

Although the wet coating thickness depends on the intended dry thickness, it is typically about 80-180 μm, but preferably 90-150 μm. The coating rate depends largely on the wet coating thickness and drying capability, and is typically about 20-500 m/min., but preferably 50-400 m/min.

The void ratio of the obtained porous ink absorbing layer is preferably 60-70%, and the void volume of the recording sheet is preferably 20-30 ml per m². Here, the expression “void volume” means (a volume of the dried layer minus a volume of solid content), which is determined employing experimental method described in Examples.

Coating the opposite side of the water base coating composition of this invention onto the substrate, is preferably applied as various backing layers to prevent curling and adhesion when stacked after printing, and further to prevent ink transferrance.

Since the structure of the backing layer may vary depending on the kinds and thickness of the substrate, and composition and thickness of the surface side layer, but generally a hydrophilic binder or a hydrophobic binder is employed. The thickness of the backing layer is usually in the range of 0.1-10 μm.

Further, the surface of the backing layer is preferably subjected to surface roughening to prevent adhesion to subsequent recording sheets, to improve writability, and to further improve transportability within the ink-jet recording apparatus. For these purposes, preferably employed are organic or inorganic micro-particles at a diameter range of 2-20 μm.

The backing layer may be applied before, or after application of the water base coating composition of this invention.

### EXAMPLES

The present invention will be further described based on examples in the following paragraphs, but is not limited to these examples. “%” in the examples indicates absolute dry %, unless otherwise noted.

### Example 1

Preparation of Silica Dispersing Water “a”

Employing Jet Stream Inductor Mixer TDS, manufactured by Mitamura Riken Kogyo Inc., 180 Kg of a gas phase silica having an average primary particle diameter of about 0.012 μm, was suction dispersed at room temperature into 520 l of purified water, its pH adjusted to 2.0 using nitric acid, after which the total volume was brought to 620 l by addition of purified water (at a pH of about 2.0).

Preparation of Silica Dispersion Solution A

To 70 l of Aqueous Solution B containing 25 weight % of a cationic polymer P-1, 10 weight % of n-propanol, and 15 weight % of ethanol, the pH of which was 2.0 and contained 2.0 g of anti-foam agent SN381, produced by San Nopco Ltd., 490 l of Silica Dispersion Water “a”, was added within the temperature range of 25-30° C. while stirring. Subsequently, 25 l of Solution C which was mixed with 4 weight % of a boric acid aqueous solution and 4 weight % of a borax aqueous solution at a ratio of 2:1, was gradually added, to the foregoing mixture of Silica Dispersion Water “a” and Aqueous Solution B while stirring.

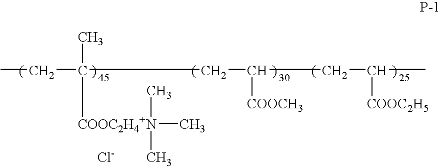

Subsequently, employing a high pressure homogenizer, manufactured by Sanwa Kogyo Co., Ltd., the resulting mixture was dispersed under a pressure of 300 Kg/cm², after which the total volume was brought to 590 l, and filtered using a TCP-30 type filter, produced by Advantec Toyo Kaisha, Ltd., featuring a filtration accuracy of 30 μm, to obtain almost transparent Silica Dispersion Solution A, the pH of the silica dispersion solution being 3.4.

Water Base Coating Composition (1)

To prepare an ink-jet recording sheet (hereinafter, referred to simply as a recording sheet), having a porous ink absorbing layer, employing foregoing Silica Dispersion Solution A, following Water Base Coating Composition (1) was prepared. Each of the values was the amount per liter of the water base coating composition. The addition was conducted in the order of the following list.

| | |
|---|---|
| Water Base Coating Composition (1) | 650 ml |
| Silica Dispersion Solution A | |
| Polyvinyl alcohol (being PVA235, produced | 270 ml |
| by Kuraray Co. Ltd.), being a 10% | |
| aqueous Solution | |
| Purified water (the total volume of which | 1,000 ml |
| was brought to) | |

The obtained water base coating composition was dispersed under 200 Kg/cm², employing the foregoing high pressure homogenizer, to obtain Water Base Coating Composition (1), at a silica content of 15.7%. Viscosity of Water Base Coating Composition (1) at 40° C. and 15° C. was measured and the resulting values are shown in Table 1 (shown in the Recording Sheet 1 column). Subsequently, Water Base Coating Compositions (2)-(5) were prepared by diluting Water Base Coating Composition (1) with purified water as described below. The viscosity of each at 40 and 15° C. was determined and the resulting values are shown in the appropriate recording sheet column in Table 1.

Water Base Coating Composition (2)

Water Base Coating Composition (1) 1,000 ml+Purified water 100 ml (at a silica content of 14.2%)
   Water Base Coating Composition (3)
Water Base Coating Composition (1) 1,000 ml+Purified water 200 ml (at a silica content of 13.1%)
   Water Base Coating Composition (4)
Water Base Coating Composition (1) 1,000 ml+Purified water 400 ml (at a silica content of 11.2%)
   Water Base Coating Composition (5)
Water Base Coating Composition (1) 1,000 ml+Purified water 500 ml (at a silica content of 9.8%)
   Preparation of Recording Sheet

Onto a paper substrate, both sides of which were covered with polyethylene, each of the water base coating compositions prepared as above, were applied at 42° C. and at the wet thickness shown in Table 1. The porous ink absorbing layer side of the 170 g/m² paper base, having a moisture content of 7.5 weight %, was covered with 25 g/m² of polyethylene containing 7 weight % of anatase type titanium oxide, and the opposite side of the paper base was covered with 34 g/m² of polyethylene. The polyethylene surface of the ink absorbing layer side was subjected to a corona discharge treatment, after which a subbing layer of about 50 mg/m² gelatin was applied. To the opposite side of the paper base, styrene-maleic acid latex and a silica type matting agent were applied, after a corona discharge treatment. The coating methods are shown in Table 1, in which, EX is an extrusion coating method, CT is a curtain coating method, and SH is a slide hopper coating method.

In Recording Sheet 1 [employed Water Base Coating Composition (1)], coating was conducted with a coating width of 1,300 mm, and at a coating rate of 150 m/min., and immediately after coating, the coated sheet was cooled for 20 sec. in a cooling zone maintained at 4° C., and then sequentially dried with 30° C. blown air (at a relative humidity of 15%) for 30 sec., at 60° C. (at a relative humidity of less than 10%) for 30 sec., at 70° C. (at a relative humidity of less than 10%) for 60 sec., and at 50° C. (at a relative humidity of about 10%) for 60 sec., after which the coated sheet was conditioned in an atmosphere of 20-25° C. and relative humidity of 40-60% for two minutes, and wound into a roll, to obtain Recording Sheet 1.

Recording Sheets 2-5 [corresponding to Water Base Coating Compositions (2)-(5)] were prepared at a lowered coating rate under similar drying conditions as Recording Sheet 1, depending on the increase of the wet coating thickness.

As a result of the cross-section observation of the porous ink absorbing layers of the recording sheets employing an electron microscope, the average particle diameter in any of the recording sheets was about 50 nm.

Subsequently, each sample was stored at 50° C. for 24 hours.

Evaluation

The void volume and the coated film layer quality (being uniformity in width, blurring streaks, reticulating streaks, and number of cracks) of Recording Sheets 1-5 were visually evaluated, the obtained results of which are shown in Table 1.

Void Volume

The recording sheet was cut into 100 cm² pieces, and the weight of each was determined (W1). It was then soaked in 23° C. purified water for 30 sec., after any adhered water on both sides was wiped off using filter paper the weight was quickly re-measured (W2).
Void Volume=(W2−W1)×100

The measurements were conducted three times, and the average was defined as Void Volume.

Uniformity in Width

Silica coverage was measured at 5 cm intervals in the lateral direction of the coated sample, and the standard deviation of variation of silica coverage was determined as g/m².

Blurring Streaks

A: No streak was noted.
B: Slight streaking was noted, but not at practical problems.
C: Obvious streaks were noted.
   Reticulating Streaks
A: Not even minute streak was noted.
B: Only very slight minute streaking was noted, but not at practical problems.
C: Obvious streaks were noted.
   Number of Cracks

A number of cracking defects of more than about 0.5 mm per m² of the recording sheet was noted.

TABLE 1

| | | | | Wet | Dry | | | | | | | |
|---|---|---|---|---|---|---|---|---|---|---|---|---|
| | Viscosity | | | thick- | thick- | Void | | Silica | Coated layer quality | | | |
| Recording | (mPa · s) | | Coating | ness | ness | volume | | content | Uniformity | Blurring | Reticulating | |
| Sheet | 40° C. | 15° C. | method | (μm) | (μm) | (ml/m²) | H/D | (%) | in width | streak | streak | Cracking |
| 1 (Comp.) | 1,500 | >100,000 | EX | 106 | 32.4 | 22.2 | 3.3 | 15.7 | 1.2 | C | A | 21 |
| 2 (Inv.) | 600 | >100,000 | EX | 117 | 32.4 | 22.2 | 3.6 | 14.2 | 0.6 | B | A | 2 |
| 3 (Inv.) | 200 | 65,000 | CT | 127 | 32.4 | 22.2 | 3.9 | 13.1 | 0.3 | A | A | 0 |
| 4 (Comp.) | 45 | 8,500 | SH | 148 | 32.4 | 22.2 | 4.6 | 11.1 | 0.3 | A | C | 0 |
| 5 (Comp.) | 21 | 1,800 | SH | 170 | 32.4 | 22.2 | 5.2 | 9.8 | 0.8 | A | C | 1 |

Note:
Comp.: comparative example
Inv.: this invention

Results of Table 1 prove that Recording Sheets 2 and 3 were superior in uniformity across the width, and no blurring streaks and reticulating streaks was observed, and only very slight streaks were observed, resulting in excellent coated layer quality.

Correspondingly, Recording Sheet 1 exhibited an H/D of 3.3 and a high void volume, however uniformity across the width of the coated layer was poor, resulting in obvious blurring streaks, in addition, numerous cracking defects were observed near the streaks.

Further, in Recording Sheets 4 and 5 which exhibited an H/D exceeding 4.2, reticulating streak defects were observed.

### Example 2

Recording Sheets 11-15 were prepared in the same manner as Recording Sheets 1-5, except that while preparing Water Base Coating Compositions (1)A-(5)A in the same manner as Example 1, 50 ml of ethanol was added to 1 liter of the water base coating composition, at the time of preparation of Water Base Coating Composition (1) of Example 1. Evaluation was conducted as the same as for Example 1, the obtained results of which are shown in Table 2.

TABLE 2

| | | | | Wet | Dry | | | | | | | |
|---|---|---|---|---|---|---|---|---|---|---|---|---|
| | Viscosity | | | thick- | thick- | Void | | Silica | Coated layer quality | | | |
| Recording | (mPa · s) | | Coating | ness | ness | volume | | content | Uniformity | Blurring | Reticulating | |
| Sheet | 40° C. | 15° C. | method | (μm) | (μm) | (ml/m²) | H/D | (%) | in width | streak | streak | Cracking |
| 11 | 650 | 90,000 | EX | 106 | 28.8 | 18.8 | 3.7 | 15.7 | 0.4 | B | A | 0 |
| (Inv.) | | | | | | | | | | | | |
| 12 | 190 | 45,000 | CT | 117 | 28.8 | 18.8 | 4.1 | 14.2 | 0.3 | A | A | 0 |
| (Inv.) | | | | | | | | | | | | |
| 13 | 60 | 12,000 | SH | 127 | 28.8 | 18.8 | 4.4 | 13.1 | 0.3 | A | C | 2 |
| (Inv.) | | | | | | | | | | | | |
| 14 | 28 | 3,400 | SH | 148 | 28.8 | 18.8 | 5.1 | 11.1 | 0.5 | A | C | 2 |
| (Comp.) | | | | | | | | | | | | |
| 15 | 18 | 900 | SH | 170 | 28.8 | 18.8 | 5.9 | 9.8 | 1.1 | A | C | 4 |
| (Comp.) | | | | | | | | | | | | |

From the results of Table 2, it is proven that Recording Sheets 11 and 12, both of which featured silica content of more than 12 weight %, viscosity of the water base coating composition at 40° C. of 0.50-1.000 PA·s, and an H/D ratio of in the range of 3.5-4.2, exhibited excellent uniform thickness across the width, as well as excellent coated layer quality of less blurring streaks, reticulating streaks and cracks.

### Example 3

Recording Sheets 21-25 were prepared in the same manner as Recording Sheets 1-5, except that Water Base Coating Compositions (1)B-(5)B, prepared in the same manner as Example 1 except that 20 ml of 5% aqueous solution of Surface Active Agent (S-1) was added per liter of the water base coating composition, at the time of preparation of Water Base Coating Composition (1) of Example 1.

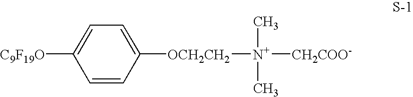

The same evaluation as Example 1 was conducted, and the results shown in Table 3 were obtained.

TABLE 3

| | | | | Wet | Dry | | | | | | | |
|---|---|---|---|---|---|---|---|---|---|---|---|---|
| | Viscosity | | | thick- | thick- | Void | | Silica | Coated layer quality | | | |
| Recording | (mPa · s) | | Coating | ness | ness | volume | | content | Uniformity | Blurring | Reticulating | |
| Sheet | 40° C. | 15° C. | method | (μm) | (μm) | (ml/m²) | H/D | (%) | in width | streak | streak | Cracking |
| 21 | 1,100 | >100,000 | EX | 106 | 31.0 | 21.2 | 3.4 | 15.7 | 0.4 | C | A | 9 |
| (Comp.) | | | | | | | | | | | | |
| 22 | 400 | >100,000 | CT | 117 | 31.0 | 21.2 | 3.8 | 14.2 | 0.3 | A | A | 0 |
| (Inv.) | | | | | | | | | | | | |
| 23 | 140 | 47,000 | CT | 127 | 31.0 | 21.2 | 4.1 | 13.1 | 0.3 | A | C | 0 |
| (Inv.) | | | | | | | | | | | | |
| 24 | 40 | 5,000 | SH | 148 | 31.0 | 21.2 | 4.8 | 11.1 | 0.5 | A | C | 0 |
| (Comp.) | | | | | | | | | | | | |
| 25 | 20 | 1,200 | SH | 170 | 31.0 | 21.2 | 5.5 | 9.8 | 0.7 | A | C | 4 |
| (Comp.) | | | | | | | | | | | | |

From the results of Table 3, it is proven that Recording Sheets 22 and 23, both of which featured a silica content of more than 12 weight %, viscosity of the water base coating composition at 40° C. of 0.50-1.000 PA·s, and an H/D ratio of in the range of 3.5-4.2, exhibited excellent uniform thickness across the width, and excellent coated layer quality of less blurring streaks, reticulating streaks and cracks.

### Example 4

Recording Sheets 31-35 were prepared in the same manner as Recording Sheets 1-5, except that Water Base Coating Compositions (1)C-(5)C were prepared in the same manner as Example 1, except that the amount of polyvinyl alcohol was reduced from 270 ml to 220 ml, and 30 ml of the following latex was added to 1 liter of the water base coating composition, at the time of preparation of Water Base Coating Composition (1) of Example 1.
Latex: Solid content was 30%
5% polyvinyl alcohol: PVA117, produced by Kuraray Co., Ltd., being an acrylic dispersion solution obtained by emulsion polymerization in an aqueous solution

The same evaluation a Example 1 was conducted, the results of which are shown in Table 4.

TABLE 4

| | | | | Wet | Dry | | | | | | | |
|---|---|---|---|---|---|---|---|---|---|---|---|---|
| | Viscosity | | | thick- | thick- | Void | | Silica | Coated layer quality | | | |
| Recording | (mPa · s) | | Coating | ness | ness | volume | | content | Uniformity | Blurring | Reticulating | |
| Sheet | 40° C. | 15° C. | method | (μm) | (μm) | (ml/m²) | H/D | (%) | in width | streak | streak | Cracking |
| 31 | 2,000 | >100,000 | EX | 106 | 33.0 | 22.8 | 3.2 | 15.7 | 1.8 | C | A | 12 |
| (Comp.) | | | | | | | | | | | | |
| 32 | 800 | >100,000 | EX | 117 | 33.0 | 22.8 | 3.5 | 14.2 | 0.6 | B | A | 0 |
| (Inv.) | | | | | | | | | | | | |
| 33 | 380 | >100,000 | CT | 127 | 33.0 | 22.8 | 3.8 | 13.1 | 0.3 | A | A | 0 |
| (Inv.) | | | | | | | | | | | | |
| 34 | 110 | >100,000 | CT | 148 | 33.0 | 22.8 | 4.5 | 11.1 | 0.3 | A | C | 0 |
| (Comp.) | | | | | | | | | | | | |
| 35 | 45 | 45,000 | SH | 170 | 33.0 | 22.8 | 5.2 | 9.8 | 0.3 | A | C | 0 |
| (Comp.) | | | | | | | | | | | | |

From the results of Table 4, it is proven that for Recording Sheets 32 and 33, both of which featured silica content of more than 12 weight %, viscosity of the water base coating composition at 40° C. was 0.50-1.000 PA·s, and an H/D ratio of in the range of 3.5-4.2, exhibited excellent uniform thickness across the width, and excellent coated layer quality of less blurring streaks, reticulating streaks and cracks.

### Example 5

Recording Sheets 41-45 were prepared in the same manner as Recording Sheets 1-5, except that Water Base Coating Compositions (1)D-(5)D was prepared in the same manner as Example 1, except that dispersion employing a high pressure homogenizer was not conducted after preparation of Water Base Coating Composition (1) of Example 1. The same evaluation as for Example 1 was conducted, the results of which are shown in Table 5.

TABLE 5

| | | | | Wet | Dry | | | | | | | |
|---|---|---|---|---|---|---|---|---|---|---|---|---|
| | Viscosity | | | thick- | thick- | Void | | Silica | Coated layer quality | | | |
| Recording | (mPa · s) | | Coating | ness | ness | volume | | content | Uniformity | Blurring | Reticulating | |
| Sheet | 40° C. | 15° C. | method | (μm) | (μm) | (ml/m²) | H/D | (%) | in width | streak | streak | Cracking |
| 41 | 6,000 | >100,000 | EX | 106 | 34.5 | 24.2 | 3.1 | 15.7 | 0.9 | C | A | 30 |
| (Comp.) | | | | | | | | | | | | |
| 42 | 1,200 | >100,000 | EX | 117 | 34.5 | 24.2 | 3.4 | 14.2 | 0.4 | C | A | 9 |
| (Comp.) | | | | | | | | | | | | |
| 43 | 830 | >100,000 | EX | 127 | 34.5 | 24.2 | 3.7 | 13.1 | 0.3 | B | A | 0 |
| (Inv.) | | | | | | | | | | | | |
| 44 | 320 | >100,000 | CT | 148 | 34.5 | 24.2 | 4.3 | 11.1 | 0.3 | A | C | 0 |
| (Comp.) | | | | | | | | | | | | |
| 45 | 80 | >100,000 | CT | 170 | 34.5 | 24.2 | 4.9 | 9.8 | 0.5 | A | C | 0 |
| (Comp.) | | | | | | | | | | | | |

From the results of Table 5, it is proven that Recording Sheets 43 and 45, both of which featured a silica content of more than 12 weight %, viscosity of the water base coating composition at 40° C. of 0.50-1.000 PA·s, and an H/D ratio of in the range of 3.5-4.2, exhibited excellent uniform thickness across the width, and excellent coated layer quality of less blurring streaks, reticulating streaks and cracks.

### Example 6

Recording Sheets 51-55 were prepared in the same manner as Recording Sheets 1-5, except that Water Base Coating Compositions (1)E-(5)E were prepared in the same manner as Example 3, except that the silica dispersion solution employed in Example 3 was replaced with the following solution.

Preparation of Silica Dispersion Solution B

To 660 l of Aqueous Solution containing cationic polymer P-1, n-propanol, ethanol, an anti-foam agent, boric acid and borax, the solution pH of which pH was adjusted to 2.0 using nitric acid (the ratio of each additive to silica being the same as that of Dispersion Solution A), 180 Kg of silica featuring an average primary particle diameter of about 15 nm, and produced via a wet method, was mixed and kneaded, after which the resulting mixture was dispersed employing a sandmill disperser, and further dispersed employing the foregoing high pressure homogenizer, after which the total volume was brought to 746 l by addition of purified water. Finally, the mixture was filtered in the same manner as Dispersion Solution A, to obtain Dispersion Solution B. The same evaluation as for Example 1 was conducted, the results of which are shown in Table 6.

TABLE 6

| | | | | Wet | Dry | | | | | | | |
|---|---|---|---|---|---|---|---|---|---|---|---|---|
| | Viscosity | | | thick- | thick- | Void | | Silica | Coated layer quality | | | |
| Recording | (mPa · s) | | Coating | ness | ness | volume | | content | Uniformity | Blurring | Reticulating | |
| Sheet | 40° C. | 15° C. | method | (μm) | (μm) | (ml/m²) | H/D | (%) | in width | streak | streak | Cracking |
| 51 | 750 | >100,000 | EX | 106 | 33.4 | 23.4 | 3.2 | 15.7 | 0.9 | C | A | 17 |
| (Comp.) | | | | | | | | | | | | |
| 52 | 420 | >100,000 | EX | 117 | 33.4 | 23.4 | 3.5 | 14.2 | 0.4 | B | A | 2 |
| (Inv.) | | | | | | | | | | | | |
| 53 | 180 | >100,000 | CT | 127 | 33.4 | 23.4 | 3.8 | 13.1 | 0.3 | A | A | 0 |
| (Inv.) | | | | | | | | | | | | |
| 54 | 80 | 29,000 | CT | 148 | 33.4 | 23.4 | 4.4 | 11.1 | 0.3 | A | C | 0 |
| (Comp.) | | | | | | | | | | | | |
| 55 | 35 | 1,800 | SH | 170 | 33.4 | 23.4 | 5.1 | 9.8 | 0.5 | A | C | 1 |
| (Comp.) | | | | | | | | | | | | |

From the results of Table 6, it is proven that Recording Sheets 52 and 53, both of which featured a silica content of more than 12 weight %, viscosity of the water base coating composition at 40° C. of 50-1.000 PA·s, and an H/D ratio of in the range of 3.5-4.2, exhibited excellent uniform thickness across the width, and excellent coated layer quality of less blurring streaks, reticulating streaks and cracks.

### Example 7

Recording Sheets 61-68 were prepared via a multilayer coating structure of an upper layer and a lower layer as shown in Table 7, employing Water Base Coating Compositions (1)E, (2)A, (3), (3)C, (3)D, (4)C, (4)D, and (4)E, prepared in Examples 1-6.

TABLE 7

| | | | Ratio of |
|---|---|---|---|
| | | | upper |
| | | | layer/lower |
| | Lower layer | Upper layer | layer |
| Recording | Water Base | Water Base | 1/1 |
| Sheet 61 | Coating | Coating | |
| | Composition (3) | Composition (2) A | |
| Recording | Water Base | Water Base | 1/1 |
| Sheet 62 | Coating | Coating | |
| | Composition (3) C | Composition (4) C | |
| Recording | Water Base | Water Base | 7/3 |
| Sheet 63 | Coating | Coating | |
| | Composition (3) C | Composition (4) C | |
| Recording | Water Base | Water Base | 9/1 |
| Sheet 64 | Coating | Coating | |
| | Composition (3) C | Composition (4) C | |
| Recording | Water Base | Water Base | 1/1 |
| Sheet 65 | Coating | Coating | |
| | Composition (4) E | Composition (3) E | |
| Recording | Water Base | Water Base | 7/3 |
| Sheet 66 | Coating | Coating | |
| | Composition (3) D | Composition (1) E | |
| Recording | Water Base | Water Base | 1/1 |
| Sheet 67 | Coating | Coating | |
| | Composition (4) D | Composition (1) E | |
| Recording | Water Base | Water Base | 1/1 |
| Sheet 68 | Coating | Coating | |
| | Composition (4) D | Composition (4) C | |

The same evaluation as Example 1 was conducted, the results of which are shown in Table 8.

TABLE 8-1

| | Viscosity | | | Wet thickness | | Dry thickness | | | | |
|---|---|---|---|---|---|---|---|---|---|---|
| | (upper layer/lower | | | (μm) | | (μm) | | Void | H/D | |
| Recording | layer) (mPa · s) | | Coating | Lower | Upper | Lower | Upper | volume | Lower | Upper |
| Sheet | 40° C. | 15° C. | method | layer | layer | layer | layer | (ml/m²) | layer | layer |
| 61 | 200/190 | 65,000/45,000 | CT | 63.5 | 58.5 | 16.2 | 14.4 | 20.5 | 3.9 | 4.1 |
| (Inv.) | | | | | | | | | | |
| 62 | 380/110 | >100,000/>100,000 | CT | 63.5 | 74 | 16.5 | 16.5 | 22.8 | 3.8 | 4.5 |
| (Inv.) | | | | | | | | | | |
| 63 | 380/110 | >100,000/>100,000 | CT | 88.9 | 44.4 | 23.1 | 9.9 | 22.8 | 3.8 | 4.5 |
| (Inv.) | | | | | | | | | | |
| 64 | 380/110 | >100,000/>100,000 | CT | 114 | 14.8 | 29.7 | 3.3 | 22.8 | 3.8 | 4.5 |
| (Inv.) | | | | | | | | | | |
| 65 | 80/180 | 29,000/>100,000 | CT | 74 | 63.5 | 16.7 | 16.7 | 23.4 | 4.4 | 3.8 |
| (Inv.) | | | | | | | | | | |
| 66 | 830/750 | >100,000/>100,000 | EX | 88.9 | 31.8 | 24.2 | 10.0 | 24.0 | 3.7 | 3.2 |
| (Inv.) | | | | | | | | | | |
| 67 | 320/750 | >100,000/>100,000 | EX | 74 | 53 | 17.3 | 16.7 | 23.8 | 4.3 | 3.2 |
| (Comp.) | | | | | | | | | | |
| 68 | 320/110 | >100,000/>100,000 | CT | 74 | 74 | 17.3 | 16.5 | 23.5 | 4.3 | 4.5 |
| (Comp.) | | | | | | | | | | |

TABLE 8-2

| | | Coated layer quality | | | |
|---|---|---|---|---|---|
| Recording | Silica | Uniformity | Blurring | Reticulating | |
| Sheet | content | in width | streak | streak | Cracking |
| 61 (Inv.) | 13.7 | 0.3 | A | A | 0 |
| 62 (Inv.) | 12.1 | 0.3 | A | B | 0 |
| 63 (Inv.) | 12.5 | 0.3 | A | A | 0 |
| 64 (Inv.) | 12.5 | 0.3 | A | A | 0 |
| 65 (Inv.) | 12.1 | 0.5 | A | B | 0 |
| 66 (Inv.) | 13.9 | 0.5 | B | A | 5 |
| 67 (Comp.) | 13.4 | 0.6 | C | C | 9 |
| 68 (Comp.) | 11.1 | 0.3 | A | C | 0 |

It is proven that when the water base coating composition of this invention was employed even in one layer, the recording sheet exhibited excellent coated layer quality.

1. A method for producing a porous ink-jet recording sheet comprising the steps of:
(i) applying a water base coating composition comprising inorganic micro-particles, polyvinyl alcohol, and substantially no gelatin onto a non-water-absorbing substrate, and
(ii) drying the applied coating composition on the substrate,
wherein a wet thickness of the water base coating composition H (μm) and a dry thickness D (μm) satisfy the following relationship:
3.5≦H/D≦4.2
a content of the inorganic micro-particles in the water base coating composition is not less than 12 weight %; and
a viscosity of the water base coating composition is 0.050 to 1.000 Pa·s at 40° C.

2. The method for producing a porous ink-jet recording sheet of claim 1,
wherein at least two kinds of water base coating compositions are simultaneously applied onto the non-water-absorbing substrate,
a wet thickness of one of the water base coating composition H (μm) and a wet thickness D (μm) satisfy the following relationship:
3.5≦H/D≦4.2
a content of inorganic micro-particles in the water base coating composition is not less than 12 weight %; and
a viscosity of the water base coating composition is 0.050 to 1.000 Pa·s at 40° C.

3. The method for producing a porous ink-jet recording sheet of claim 1,
wherein a viscosity of the water base coating composition at 15° C. is at least 20 times that of the viscosity at 40° C., and
the water base coating composition is applied onto the non-water-absorbing substrate in the range of 35 to 50° C.

4. The method for producing a porous ink-jet recording sheet of claim 1, wherein after the water base coating composition is applied onto the non-water-absorbing substrate, the temperature of the applied layer is cooled to less than 20° C. to increase viscosity, and is dried with a warm air current.

5. The method for producing a porous ink-jet recording sheet of claim 1, wherein a layer resulting from applying the water base coating composition onto the non-water-absorbing substrate and drying is a porous ink absorbing layer, and a void ratio of the porous ink absorbing layer is 60 to 70%.
